(19) United States
(12) Patent Application Publication
(10) Pub. No.: US 2005/0058884 A1
(43) Pub. Date: Mar. 17, 2005

(54) Flooded valve regulated battery cell

(76) Inventor: William E. M. Jones, Freeport (BS)

Correspondence Address: SYNNESTVEDT & LECHNER, LLP, 2600 ARAMARK TOWER, 1101 MARKET STREET, PHILADELPHIA, PA, 191072950, US

(21) Appl. No.: 10/929,245

(22) Filed: Aug. 30, 2004

Related U.S. Application Data
(60) Provisional application No. 60/498,632, filed on Aug. 28, 2003.

(51) Int. Cl. H01M 2/12; H01M 10/52; H01M 10/04

(52) U.S. Cl. 429/54; 429/82; 429/59; 29/623.2

(57) ABSTRACT

A flooded valve regulated battery cell has a secondary negative plate in contact with a gas space in which oxygen from the cell reaction collects, and which is further in contact with the electrolyte. The secondary negative plate is electrically connected to the negative plate of the cell. Oxygen is recombined to form water at the secondary negative plate. A vent assembly in accordance with the present invention is provided, as is a method of converting conventional flooded cells into valve regulated cells.

### CROSS REFERENCE TO RELATED APPLICATION

This application claims the benefit of U.S. Provisional Application No. 60/498,632, filed Aug. 28, 2003, and which is hereby incorporated by reference herein.

### FIELD OF THE INVENTION

This invention relates to improvements in storage battery cells with regard to a reduction in water consumption during operation and service. More specifically, it relates to an improved design for a simple and reliable valve regulated (VR) battery cell. The invention will be described in terms of the lead-acid VR cell variety used in stationary applications, but may be equally applied to other cell types and other applications by anyone of ordinary skill in the art.

### DESCRIPTION OF RELATED ART

a. Traditional Flooded Cells

The traditional flooded cell has positive and negative plates immersed in an electrolyte solution. A porous separator between the plates prevents any electrical contact between them. The plates are electrically connected by respective straps to positive and negative terminals (posts) positioned outside the cell for connection to an electric circuit.

A classic application for such a battery is standby power for computers or telephone systems. Here, the cells are placed on racks, connected in series, and charged or “floated” continuously at a controlled voltage.

This continuous charging has the effect of consuming water by electrolysis; that is, water is broken down into oxygen gas (0₂) at the positive plate and hydrogen gas (H₂) at the negative plate. These gasses rise to the surface of the electrolyte as bubbles and escape through a vent hole in the top of the cell.

The water consumption of flooded cells has been reduced to a minimum by charging the cells at the lowest possible voltage, but the cells still require water additions from time to time. Large stationary batteries, for example, may need watering every year in some applications which, in remote sites and with ever increasing labor costs, is expensive for the owner of the batteries.

It is, therefore, a commercial benefit to have batteries that do not require water additions, and there has been a great effort expended by the battery industry to develop sealed “valve regulated” (VR) cells. These VR cells use a different technology to reduce water consumption.

b. Valve Regulated Batteries

The valve regulated lead acid (VRLA) cell has similar kinds of plates that a flooded lead acid cell contains. Unlike a flooded cell, however, the VRLA cell has a pressure relief valve that permits escape of pressurized gas but does not allow external air (containing atmospheric oxygen) to enter the cell. Thus, in a valve regulated cell on charge, oxygen gas produced from the electrolysis of water, instead of bubbling to the surface of the electrolyte and venting from the cell as in a flooded cell, is recombined on the negative plates with hydrogen ions and electrons to re-form water, thereby reducing the water consumption of the cell. The negative plates, therefore, cannot be fully submerged in the electrolyte. Rather, a portion of the negative plates must be exposed directly to the oxygen gas.

The two most common types of valve regulated lead acid cells are Gel cells and AGM cells which contain an immobilized electrolyte, as compared with flooded cells where the electrolyte is in a free liquid form. Gel cells contain a gelled electrolyte while AGM cells contain a micro-porous glass mat to immobilize the electrolyte. In the case of the Gel cell, oxygen is believed to reach the negative plates through cracks in the gel material as it dries out. In the case of the AGM cell, the oxygen passes through the separator where it is not fully saturated with electrolyte to the negative plate. A third type of VRLA cell is described in U.S. Pat. No. 6,274,263 and which is hereby incorporated by reference herein. In this design, the tops of the negative plates physically emerge above the liquid electrolyte level to provide a direct and controllable area on which the oxygen can recombine. All VRLA cell types must have a check valve or pressure relief valve to prevent the ingress of atmospheric (excess) oxygen which would “depolarize” or cause self-discharge of the negative plates.

While valve regulated cells using immobilized electrolytes have become common, it is believed that providing a valve regulated cell using a flooded electrolyte can provide advantages, and extend the application of valve regulated technology to other types of batteries and service.

One object of the present invention is to provide a flooded valve regulated cell that is easy and economical to produce.

Another object of the present invention is to provide a means for converting conventional flooded battery cells to valve regulated cells.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations pointed out in the appended claims.

### SUMMARY OF THE INVENTION

Broadly, the objects and advantages of the present invention are attained by a valve regulated battery cell having a sealed container, a liquid electrolyte within the container, and a gas space in which oxygen from within the cell collects. At least one positive plate and one negative plate are immersed in the electrolyte.

For recombining oxygen, a secondary negative plate is positioned to be in gas communication with the gas space and in contact with the electrolyte. The secondary negative plate is electrically connected to the negative plate. A pressure relief valve is positioned in the battery to allow excess gas to escape the battery while preventing oxygen from outside the cell from entering the cell. The secondary negative plate recombines oxygen gas from the gas space with hydrogen ions from the electrolyte and electrons from the charger to form water.

The present invention further provides a vent assembly for closing a vent opening of a battery. The vent assembly includes both a pressure relief valve and a secondary negative plate. In another form of the invention, the invention provides a method of converting a conventional flooded electrolyte battery to a valve regulated battery. In another embodiment, the invention provides a catalyst for combining oxygen and hydrogen gas in addition to the secondary negative plate.

### BRIEF DESCRIPTION OF THE DRAWINGS

The accompanying drawings, which are incorporated in and constitute a part of the specification, illustrate presently preferred embodiments of the invention. Together with the general description given above and the detailed description of the preferred embodiments given below, they serve to explain the principles of the invention.

FIG. 1 is a schematic view of a VRLA cell in accordance with the present invention;

FIG. 2 is a schematic view of another embodiment of a VRLA cell in accordance with the present invention; and

FIG. 3 is a schematic view of third embodiment of a VRLA cell in accordance with the present invention.

### DETAILED DESCRIPTION

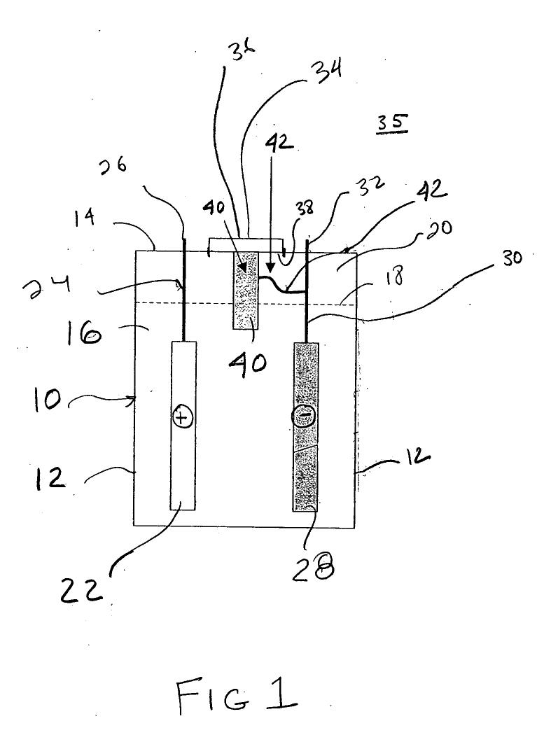

The invention is now described with reference to FIGS. 1 to 3 depicting valve regulated (VR) cells of the lead acid cell variety (valve regulated lead acid cells are also known as VRLA cells). It is understood, however, that the invention is not so limited, and is to be limited only by the claims appended hereto:

With reference to FIG. 1, a basic form of the present invention is now described. The storage battery cell 10 has a container 12, which includes a container cover 14, to provide a sealed enclosure for maintaining liquid and gas within as known in the art. Typical container materials include ABS, SAN, polypropylene and other suitable materials. Contained within the container 12 is a suitable liquid (flooded) electrolyte 16, which, in lead acid cells, is a solution of sulfuric acid. The electrolyte 16 has a liquid level 18 above which is a gas space 20, between the liquid level 18 and the container cover 14, in which oxygen and hydrogen gas generated in the cell collects.

The cell 10 includes a positive plate 22 immersed in the electrolyte 16. The positive plate 22 is electrically connected through a conductor 24 to a positive post or terminal 26 which, in the present embodiment, extends through the container cover 14 in a sealed manner to be liquid/gas tight as known in the art. The positive plate 22 can be provided as multiple positive plates as known in the art, such multiple plates typically being electrically connected through a bus bar within the container 12 which is connected to the post 24 in a manner known in the art. The positive plate 22 can be flat as shown, or any other shape or configuration as known in the art. The positive plate includes a suitable active material for the cell reaction as is known in the art, such as lead dioxide in lead acid batteries.

The cell 10 further includes a negative plate 28 immersed in the electrolyte 16. The negative plate 28 is electrically connected through a conductor 30 to a negative post or terminal 32 which, in the present embodiment, extends through the container cover 14 in a sealed manner to be liquid/gas tight. As with the positive plate 22, the negative plate 28 can be provided as multiple negative plates, such multiple plates typically being electrically connected through a bus bar within the container 12 which is connected to the negative post 32 in a manner known in the art. The negative plate 28 is flat in the present embodiment, but other designs and configurations are possible and known. The negative plate 28 includes a suitable active material for the cell reaction as is known in the art, such as lead, usually a porous lead, in lead acid batteries. The positive and negative plates, generally much closer together than illustrated, are preferably separated electrically from one another by a separator as known in the art.

A pressure relief valve 34, preferably suitable for use with VR batteries, is positioned to allow excess gas to escape from within the container 12 to the environment 35 outside the container 12. Such a pressure relief valve 34 can be provided as part of a vent assembly which is configured to seal closed a vent opening 38.in the container 12. The pressure relief valve 34 is in gas (fluid) communication with the gas space 20 so that the gas can escape from the cell 10 when the pressure within reaches a predetermined level. This protects the cell 10 from over pressurization while preventing the ingress of atmospheric oxygen. Suitable pressure relief valves 34 are well known in the art.

A secondary negative plate 40 is provided for recombining the oxygen gas in the cell 10 with hydrogen ions in the electrolyte 16 to form water. The secondary negative plate 40 is positioned to be in gas communication with the gas space 20 so as to be in contact with the oxygen gas and, can be mounted within the gas space 20 as shown, or in any space that is in gas communication with the gas space 20 so as to contact the oxygen gas. The secondary negative plate 40 is also in contact with the electrolyte 16 to provide the hydrogen ions for the oxygen recombination process which is believed to take place on the exposed electrolyte wetted surfaces of the secondary negative plate 40. Such contact with the electrolyte can be direct or indirect conduct, as long as the electrolyte can contact the secondary negative plate 40 to provide hydrogen ions thereto, or put another way, the secondary negative plate is in ionic contact with the electrolyte. In the present embodiment, this contact with the electrolyte is provided by immersing the lower portion of the secondary negative plate 40 in the electrolyte 16 at least a few millimeters, i.e., direct contact with the electrolyte, although future water loss over the life of the cell 10 should be taken into account. This embodiment relies on the wicking action of the active material used for the secondary negative plate 40 to draw the electrolyte up to and wet the surface area of the secondary negative plate 40. In other embodiments, as further discussed below, the electrolyte can be provided for contact with the secondary negative plate 40 through an intermediary member, such as a separate wick member, i.e., indirect contact with the electrolyte.

The secondary negative plate is preferably formed of active material similar to that of the negative plate 28 and which is similar to that used in conventional valve regulated cells. For example, in a lead acid cell, the negative plate is preferably made from a porous lead active material as found in the negative plate 28. Pasted plates having a lead alloy grid is such a suitable form. Porous lead has a strong wicking action that draws the electrolyte up to itself, thereby wetting its surface area. As preferred for the negative plates in conventional VRLA cells, uncontaminated pure lead (at least about 99.999% lead) is preferred for the secondary negative plate 40 in lead acid cells (without antimony or other such impurities or contaminates). Such a plate can have lead or lead alloy grids (without antimony) that are pasted with a normal lead acid battery negative active material made from very pure uncontaminated lead. Sheets of pure lead may also be suitable for the secondary negative plate 40. The effective or developed surface of the secondary negative plate 40 may be far greater than the apparent area. This may be due to the porosity of the plate active material which may be adjusted by control of the pore size, or due to grooving, perforating or otherwise increasing the apparent plate area.

Alternatively, the secondary negative plate 40 may be made of other electrically conductive materials that will survive in a battery environment, for example, solid or porous carbon. In this case, or any other case where the secondary negative plate material does not have a sufficient wicking action to wet its surface area, a separate wick member may be used to deliver the electrolyte to the secondary negative plate 40 and wet the surface area. Suitable wick member materials include those similar to the wick in an oil lamp and can be made, for example, from a woven or non-woven polyester cloth. Another secondary negative plate variation would be a mesh made with a suitable stainless steel such as 316 or Hastelloy made by the Haines Company. Since the plate is cathodically protected from corrosion, these steels will not corrode and contaminate the battery.

The secondary negative plate 40 is electrically connected to the negative plates 28 by means of a suitable electrical conductor 42. In the present embodiment, where the conductor 42 is positioned within the cell 10 as shown, the conductor should be made of a material suitable for the environment inside a battery cell, a soft lead wire being an example of such a suitable conductor for a lead acid battery. The conductor 42 is suitably connected at one end to the secondary negative plate 40 and at its other end to the negative conductor 30 or post 32 inside the cell 10. Suitable connection means include soldering, welding, or mechanical means such as screws or bolts.

The size of the secondary negative plate 40 is a function of the amount of oxygen to be recombined. This in turn is a function of the charging current. It is contemplated that those skilled in the art, in view of the teachings contained herein, will be able to readily determine for any particular application the size, or range of sizes, suitable for of the secondary negative plate 40. For example, for lead acid standby (stationary) cells, only a small charging current is used, e.g., 10-20 mA per 100 Ah battery capacity, so only a small surface area of the second negative plate 40 is required for full recombination of the oxygen. Here, it is contemplated that that the secondary negative plate will have at least about 2 square inches, and more preferably about 4 square inches, of surface area per 100 Ah (amp hours) of cell capacity for valve regulated lead acid cells that have pure lead (99.999% lead) negative active material for the negative plate and the secondary negative plate, although a lesser amount may be suitable. For a flat plate as illustrated in FIG. 1, the surface area includes both sides of the secondary negative plate 40 that is wetted by the electrolyte and exposed to the oxygen. It is understood that the surface area of the secondary negative plate 40 for purposes of the recombination does not include that portion of the plate 40 immersed in the electrolyte as the oxygen gas does not contact the plate 40 below the electrolyte level. It is also appreciated that the rate of recombination of the oxygen with hydrogen ions on the secondary negative plate 40 is also a function of the internal cell pressure. An internal pressure, generally controlled by the pressure relief valve, of at least 1.5 psi is believed suitable, with a pressure of at least 3 psi being more preferred, although other pressures may be suitable. In general, it is preferable to oversize the secondary negative plate 40 to ensure full recombination, although as further discussed below, this may not always be desirable, particularly when retrofitting conventional flooded cells which typically have lead negative plates that contain impurities such as antimony. For motive power cells, which are charged at a higher rate, e.g., 1000-2000 mA per 100 Ah, a secondary negative plate surface area several times that believed suitable for standby cells is believed preferred. Furthermore, a higher cell pressure is believed preferred for high current applications in order to minimize the surface area required.

As an example of a contemplated preferred VRLA cell in accordance with the present invention, a standby lead acid cell of 500 Ah capacity having at least 99.999% pure lead material for the negative plate 28 and secondary negative plate 40, might have a secondary negative plate 40 having a surface area of about 20 square inches exposed to the oxygen and wetted with electrolyte to be in contact therewith, and an internal pressure of 3 psi. Again, other configurations are believed possible. If the lead is less pure than 99.999%, the negative plates may self-discharge due to the effect of the impurities. In this case, the addition of a catalyst as discussed below may be preferred.

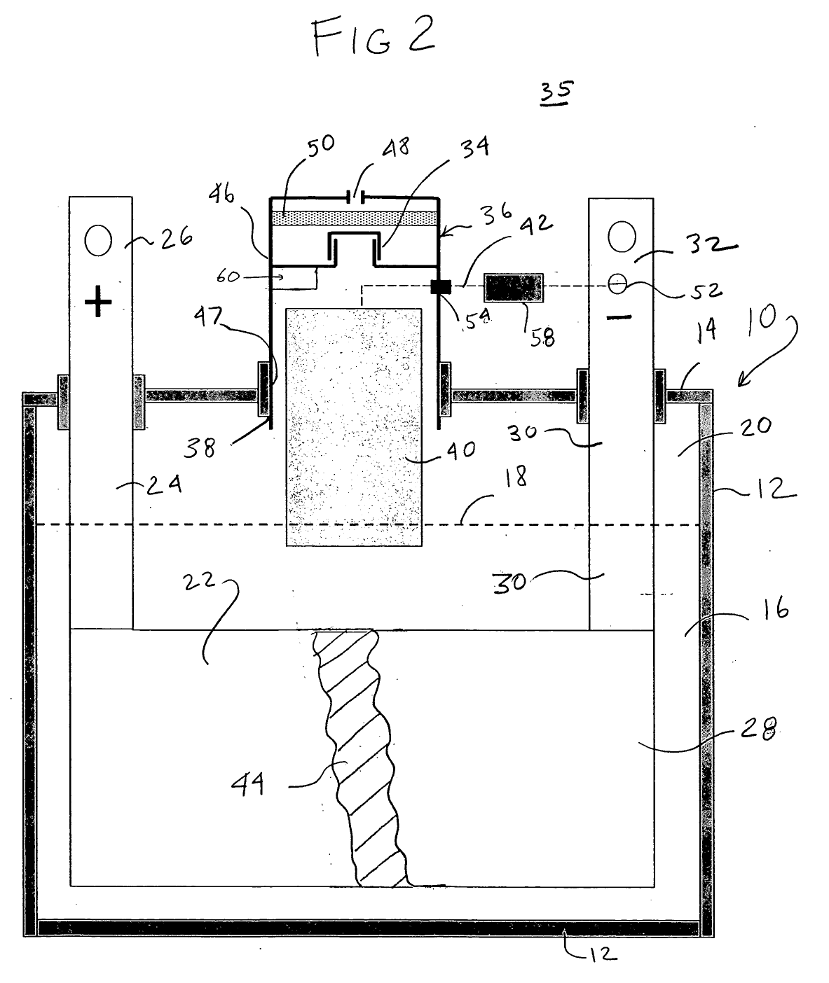

With reference to FIG. 2, another preferred embodiment of the present invention is now described. The cell of FIG. 2 has similar elements as those in FIG. 1, with like elements identified by the same reference numbers. Here, the battery cell 10 is similar to that described above, having a container 12 with a container cover 14, a liquid electrolyte 16 having a liquid level 18, and multiple positive and negative plates 22 and 28, respectively, separated from one another by a separator 44 as known on the art (one positive plate, one negative plate, and one separator being partially shown). The positive and negative plates 22, 28 are immersed in the electrolyte 16. A vent opening 38 is provided in the cover 14, a negative post 32 and a positive post 26 extend sealingly through the cover 14.

A vent assembly 36 sealingly closes the vent opening 38. The vent assembly 36 has a body 46 having a body portion 47 that is configured for sealingly closing the vent opening 38 to create a gas tight seal as know in the art of VR cells. Mounted within the vent body 46 is the pressure relief valve 34 that releases excess gas from the gas space 20 when a certain pressure is reached within, e.g. typically between 1 to 10 psi, 1.5 to 3 psi believed to be most common with VRLA cells, and 3 psi believed to be a preferred pressure for lead acid standby cells of the present invention. The excess gas, released by the pressure release valve 34 vents through the opening 48 to the atmosphere or environment outside the cell 10. The vent assembly 36 further includes a flame arrestor 50 which allows the excess gas to exit the vent assembly 36 while preventing a flame from passing though and causing an explosion. Any suitable flame arrestor material as used in the art may be used, such as a plastic material having pores of a size to prevent the ingress of a flame.

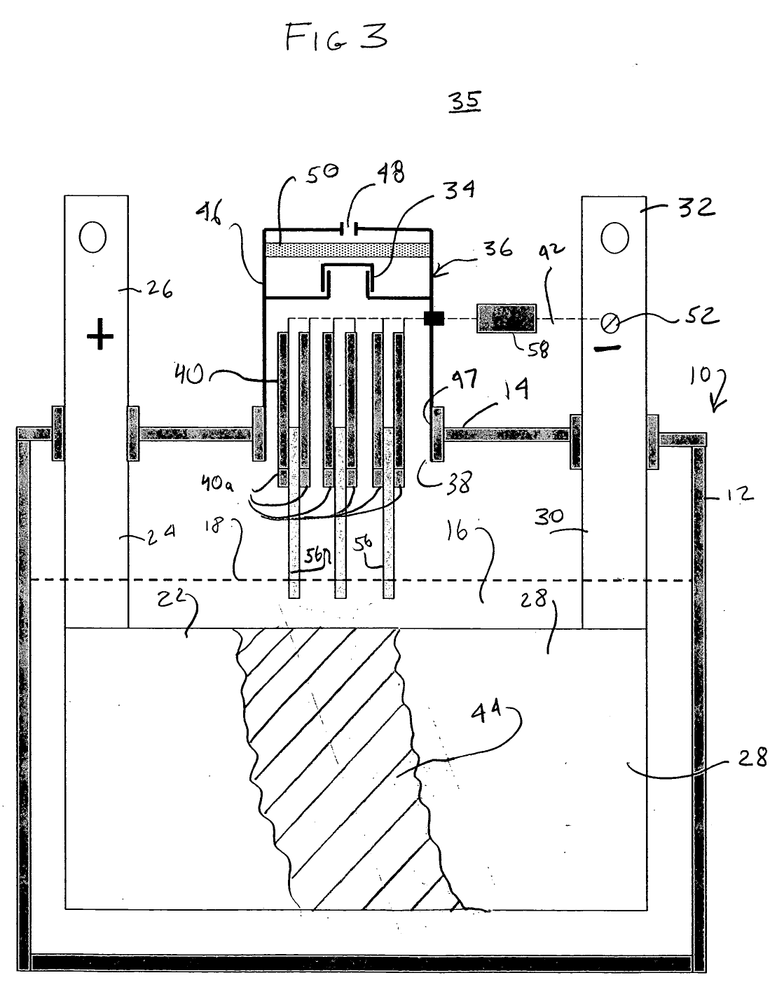

In this embodiment, the secondary negative plate 40 is combined with the vent assembly 36. The secondary negative plate 40 is mounted to the vent assembly 36 by any suitable means on the internal cell side of the pressure relief valve 34 to be in gas communication with the gas space 20, here being placed directly into the gas space 20 when the vent assembly 36 is installed in the vent opening 38. Where a material capable of wicking electrolyte is used for the secondary negative plate 40, e.g., porous lead, the secondary negative plate 40 can be configured to extend into the electrolyte 16 a suitable distance to permit wicking and thus wetting with electrolyte of the surface area of the secondary plate 40. While the plate 40 need be in contact with the electrolyte just enough to allow wicking, about a few millimeters, the lowering of the electrolyte level due to use of the cell 10 should be taken into account to ensure that the secondary negative plate 40 stays in contact with the electrolyte for the life of the cell 10. It is appreciated that the surface area of the secondary negative plate 40 can be increased by adding multiple secondary plates 40 as further described below with reference to FIG. 3, or by providing curved, coiled or rolled plates 40, e.g., a swiss roll plate 40.

An electrical conductor 42 electrically connects the secondary negative plate 40 to the negative plates 22. While any suitable conductor may be used, in the present embodiment this conductor 42 takes the form of an insulated lead wire soldered at one end to the secondary negative plate 40 within the vent assembly 36, and connected at its other end to the negative post 32 by mechanical means, such as a screw or bolt 52. In the illustrated embodiment, since the conductor 42 passes through an opening 54 in the body 46, the opening 54 should be sealed in a gas tight manner.

As discussed above, a secondary negative plate 40 of porous lead, at least 99.999% pure lead, is preferred. Similarly, pure lead should be used for the negative plate as well as is preferred in valve regulated lead acid cells.

A third embodiment of the present invention is now described with reference to FIG. 3. The cell of FIG. 3 is similar to that of FIG. 2, with like elements identified by the same reference numbers. The embodiment of FIG. 3 has a secondary negative plate 40 of a different configuration than that of FIG. 2. Here, the secondary negative plate 40 mounted in the body 46 of the vent assembly 36 is formed as one or multiple plates 40a which are electrically connected together and, which are electrically connected to the negative plate 28 via an insulated wire 42 connected to the negative post 32. Additionally, the secondary negative plates 40a are not in direct contact with the electrolyte 16, but are in contact with the electrolyte 16 through wick members 56.

Here, the secondary negative plate 40 is in indirect contact with the electrolyte. Through a wicking action, the wick members 56, each being in contact with the secondary negative plates 40a as shown, provide electrolyte to wet the surfaces of the negative plates. The wick members 56 could cover the entire surface area of the plates 40a to wet the surface areas if needed, but where the secondary negative plates can themselves wick up electrolyte sufficiently to wet the plate surface area, e.g., porous lead as preferred for the present embodiment, the wick members 56 need not cover the plates' entire surfaces, but may be truncated to permit freer access of the oxygen gas to the plates. The wick members 56 are preferably made of a “weak” wicking material that will not become too saturated, i.e., a material that will wick the electrolyte to the secondary negative plate 40 and still remain porous and gas permeable to allow oxygen to permeate to the secondary negative plate 40. The entire surface of the secondary negative plate 40 could be covered with a wick member 56 as long as the wick member material is of a type to allow oxygen to permeate to the secondary negative plate 40. A micro glass fiber separator mat of the type used in VRLA cells could be used, but because it is a very good wick and thus becomes saturated with electrolyte so that oxygen cannot permeate through to the negative plate 40, such a wick should be used only in a truncated manner as shown in FIG. 3 with the majority of the secondary negative plate 40 remaining uncovered, or the wick member should have a suitable number of holes therein to provide the necessary plate surface area for the recombination reaction. As discussed previously, any suitable wick member materials can be used, including woven polyester cloth which has twisted yarns which is believed to provide the wicking function and holes between the yarns that provide oxygen access. If required to wet the desired surface area of the secondary negative plate 40, the wick member can cover the entire surface area, although access to the secondary plate 40 surface area for the oxygen must be provided, such as by use of a weak wick material or holes in the wick member. Of course, if a porous secondary negative plate material such as porous lead is used, the wicking action of the plate allows minimal contact with the wick and thus a stronger wick member material may be used. The plates and/or the wicks may be flat, curved, concentric, spirally round or made in any other suitable shape that maximizes the reactive surface area.

Thus it is seen that a flooded electrolyte valve regulated cell is provided. Ideally, the cell is constructed specifically for valve regulated use, and thus would include materials typically used for such use, e.g., pure lead negative plates 28.

On the other hand, it is appreciated that the present invention can be used to retrofit or convert conventional flooded cells to valve regulated cells. For example, a typical flooded cell could be similar in construction to the cell shown in FIGS. 2 or 3, but would not have a pressure relief valve 34 or the secondary negative plate 40. Instead, a conventional flooded cell would have a vent plug in the vent opening 38 that permits free venting of the gas from within the cell 10. A conventional cell may also have other potential points of venting. The addition of a secondary negative plate 40 wired to the negative plate 28 and a pressure relief valve 34, as well as sealing any other vent openings in the container 12 of the cell 10, would convert the conventional flooded cell to a valve regulated cell as shown. In retrofitting, however, there may be additional concerns.

For example, a conventional flooded lead acid cell could be converted to a VRLA (valve regulated lead acid) cell. A vent assembly 36 having a pressure relief valve 34 and a secondary negative plate 40 of the type shown in FIG. 2 or 3 could be added to seal closed the vent opening 38. Any other point of venting on the cell container 12 should also be sealed closed to make the container 12 gas tight. The electrical conductor 42 is then attached to the negative post 32. This would create a VRLA cell 10. However, the plates of conventional flooded lead acid cells, unlike the materials preferred for many VRLA cells, typically contain additives or impurities such as antimony to help stabilize the cell voltage. Due to such impurities, it may be desirable to not recombine all the oxygen gas on the secondary negative plate 40 as this may over depolarize the negative plate 28, causing it to self-discharge. Thus a secondary negative plate 40 with an undersized surface area may be more preferable for such retrofitting. To recombine the excess oxygen not recombined by the secondary negative plate 40, a catalyst device for recombining oxygen and hydrogen gas to water (usually in the form of water vapor) may be used. Such a catalyst would be placed in gas communication with the gas space 20. Examples of suitable catalyst devices are disclosed in U.S. Pat. No. 6,660,425 and PCT publication WO 99/41798, both of which are hereby incorporated by reference herein. As disclosed in these references, a catalyst can also be added to the vent assembly 36 as illustrated in FIG. 2, the catalyst being designated as reference no. 60.

A further embodiment of the present invention provides means for controlling the cell voltage, particularly the voltage of cells on float, i.e., on standby and receiving a maintenance charging current. One of the problems of connecting many cells in series is that their voltages tend to vary. This is believed to be due to the tiny variations in cell materials or conditioning and can be difficult to eliminate. One solution, at least with conventional flooded lead acid cells, has been to slightly “poison”, i.e., add impurities to the cells. While this helps stabilize the cell voltages, it also increases water loss and consequent maintenance. The present invention provides a means for stabilizing cell voltages without such drawbacks. Since it is believed preferred to use pure lead plates in manufactured VRLA cells (not retrofitted conventional flooded cells), and not include impurities to stabilize the cell voltage, the present invention further provides a means to stabilize such cells without resorting to the addition of such impurities. This means is now described with reference to either of FIGS. 2 or 3.

If the current flowing along the electrical conductor 42 is high, it follows that a large number of electrons is being delivered to the secondary negative plate 40 and that the oxygen recombination reaction rate is high. As a result, the negative plate voltage must decrease (depolarize) which in turn, will cause the cell voltage to decrease. Conversely, if the current flow along the conductor 42 is reduced, the minimum being zero, the negative plate voltage will rise and cause the cell voltage to rise. Thus, varying the resistance of the conductor 42 can raise or lower the cell's 10 voltage independently of the voltages of the rest of the string of cells 10, thereby providing a means for controlling the voltage. As shown in FIGS. 2 and 3, an electronic polarization controller 58 for controlling the current in the conductor 42 is provided. Preferably, the polarization controller 58 controls the resistance of the conductor 42 to control the current flow. For example, the polarization controller can be a simple variable resistor or potentiometer which may be adjusted manually during initial battery cell installation and from time to time thereafter, or a more sophisticated and preferred option of an automatic controller that continuously or intermittingly monitors the cell float voltage and adjusts the resistance value to maintain the cell at the desire float voltage. The controller may compare the actual cell voltage with a defined ideal cell voltage and adjust the resistance accordingly.

Another benefit to automatic polarization control is that it can automatically vary the cell voltages to provide the best operating life for the cells. As an example, it could reduce the charging overvoltage (usually 100 mV on a lead-acid battery on float charge) to 80 mV or less once the battery reached full charge. That would reduce the amount of overcharge received by the cells and could extend the life of a 20 year battery by several years with obvious commercial benefit.

The arrangements discussed above with reference to FIGS. 2 and 3 makes for a convenient VR assembly, but it is understood that the secondary negative plate 40 need not be combined with a pressure relief valve 34. For example, the secondary negative plate 40 could be attached to a vent plug that does not have the pressure relief valve, the pressure relief valve being placed in another vent opening. It is also appreciated that the secondary negative plate 40 need not be placed directly within the gas space 20. For example, the section of the body 46 of the vent assembly 36 above the vent opening 38 could be much wider than the vent opening 38, having a narrower insertion portion 47 for insertion into the vent opening 38. The secondary negative plate 40 or plates could then sit within this wider area of the body which, being on the cell side of the pressure relief valve 34, is still in full gas communication with the gas space 20. A wicking material as discussed above could extend from the plate 40 to the electrolyte 16 to wick electrolyte to the secondary negative plate 40.

While the invention was discussed as it relates to lead acid cells, other aqueous type cells may also be used. For example the invention is believed to be applicable to nickel-cadmium or nickel-iron cells. Here the negative active material of the nickel-cadmium and nickel-iron cells, typically oxides of cadmium and iron respectively, may be used as the secondary negative plate 40. A suitable wicking member material may include materials such as nylon fabric which is believed compatible with the potassium hydroxide electrolyte.

The present invention thus provides a novel and advantageous valve regulated battery. In one embodiment, a valve regulated lead acid cell of the present invention, having a flooded or liquid electrolyte, has much more acid in it as compared with other conventional VRLA cells, providing a VRLA cell having more capacity and a longer life. Another advantage of the present invention is that it provides for the retrofitting of existing cells already in service. As another advantage, it is easy for a battery manufacturer to convert their existing designs to a valve regulated format with relatively low capital expenditure. The present invention also has the potential of having adjustable plate polarizations (means for voltage control) to give more uniform cell voltages and longer plate life.

It is understood that the above identified arrangements are merely illustrative of the many possible specific embodiments which represent applications of the present invention. Numerous and varied other arrangements can readily be devised in accordance with the principles of the invention without departing from the spirit and scope of the invention.

1. A valve regulated cell comprising:
a sealed container;
a liquid electrolyte within said container, said electrolyte having a liquid level;
a gas space in which oxygen generated from within the cell collects;
at least one positive plate immersed in said electrolyte;
at least one negative plate immersed in said electrolyte;
a secondary negative plate positioned to be in gas communication with said gas space and in contact with said electrolyte, said secondary negative plate being electrically connected to said negative plate; and
a pressure relief valve disposed in said cell to allow excess gas to escape said container while preventing oxygen from outside said container from entering said cell.

2. A valve regulated cell in accordance with claim 1 wherein said cell is a lead acid cell, said negative plate comprises an active material that includes lead, and said secondary negative plate includes active material that includes lead.

3. A valve regulated cell in accordance with claim 1 comprising multiple negative plates electrically connected to one another and immersed in said electrolyte, said secondary negative plate being positioned above said negative plates and electrically connected to said negative plates through an electrical conductor.

4. A valve regulated cell in accordance with claim -2 wherein said secondary plate is partially immersed in said electrolyte for direct contact therewith.

5. A valve regulated cell in accordance with claim 2 further comprising a wick member in contact with said secondary negative plate above a liquid level of said electrolyte, and which is in direct contact with said electrolyte for providing electrolyte to said secondary negative plate.

6. A valve regulated cell in accordance with claim 2 further comprising a vent assembly which includes said pressure relief valve and said secondary negative plate, and which is configured to seal a vent opening in said container, and said secondary negative plate is electrically connected to said negative plate through an electrical conductor.

7. A valve regulated cell in accordance with claim 6 wherein said electrical conductor extends from said vent assembly outside said container to a conductor in electrical contact with said negative plate.

8. A valve regulated cell in accordance with claim 2 further comprising means for controlling the cell voltage.

9. A valve regulated cell in accordance with claim 8 wherein said voltage means comprises a variable resistor.

10. A valve regulated cell in accordance with claim 5 wherein said wick member is in contact with a substantial portion of said secondary negative plate so as to provide said electrolyte to said secondary negative plate.

11. A valve regulated cell in accordance with claim 1 further comprising a vent assembly which includes said pressure relief valve and said secondary negative plate, and which is configured to seal a vent opening in said container, and wherein said secondary negative plate is electrically connected to said negative plate through an electrical conductor.

12. A valve regulated cell in accordance with claim 1 wherein said cell is a nickel cadmium or nickel iron cell, said negative plate includes an active material that includes cadmium, and said secondary negative plate includes active material that includes cadmium or iron.

13. A valve regulated cell in accordance with claim 12 wherein said secondary plate is partially immersed in said electrolyte.

14. A valve regulated cell in accordance with claim 12 further comprising a wick member in contact with said secondary plate above a liquid level of said electrolyte and in contact with said electrolyte for providing electrolyte to said secondary negative plate.

15. A valve regulated cell in accordance with claim 2 wherein said negative plate and said secondary negative plate comprise substantially pure lead.

16. A storage cell vent assembly for sealing a vent opening in a sealed container of a storage cell, wherein said cell includes an electrolyte within the container, at least one negative plate immersed in the electrolyte, a gas space in which oxygen gas collects, and a negative post electrically connected to the negative plate and extending sealingly through the container; said vent plug comprising:
a body having a body portion configured for insertion into said vent opening;
a pressure relief valve positioned for allowing excess gas to escape from within the cell container to the atmosphere outside the cell;
a secondary negative plate mounted to said assembly so as to be in gas communication with the gas space and in contact with said electrolyte when said vent assembly is installed in said vent opening; and
an electrical conductor for electrically connecting said secondary negative plate to the negative plate when said vent assembly is installed in said vent opening.

17. A vent assembly in accordance with claim 16 further comprising a flame arrestor positioned such that gas exiting said pressure relief valve must pass there through.

18. A vent assembly in accordance with claim 16 wherein a portion of said secondary negative plate is immersed in the electrolyte when said vent assembly is installed in said vent opening to provide direct contact of said secondary negative plate with said electrolyte.

19. A vent assembly in accordance with claim 16 wherein said secondary negative plate comprises multiple plates.

20. A vent assembly in accordance with claim 16 wherein at least a portion of said secondary negative plate is positioned within said body to be above a container cover of said container when said vent plug is installed in said vent opening.

21. A vent assembly in accordance with claim 16 wherein said secondary negative plate is positioned within said body to be above a container cover when said vent assembly is installed in said vent opening.

22. A vent assembly in accordance with claim 16 further comprising a wicking member in contact with said secondary negative plate and configured to contact said electrolyte when said vent assembly is installed in said vent opening to provide indirect contact of said secondary negative plate to said electrolyte.

23. A vent assembly in accordance with claim 22 wherein said secondary negative plate is positioned completely above the electrolyte within said container when said vent assembly is installed in said vent opening.

24. A vent assembly in accordance with claim 16 wherein said conductor comprises an electrical wire having one end connected to said secondary plate and a second end capable of electrical connection to the negative post, said wire extending through said body in sealed manner.

25. A vent assembly in accordance with claim 16 further comprising means for controlling the voltage of the cell when the vent assembly is installed in said vent opening.

26. A vent assembly in accordance with claim 16 wherein said secondary negative plate comprises porous lead.

27. A method for making a valve regulated cell using a cell having a flooded electrolyte; comprising:
(a) providing said flooded cell, said cell having a container, positive and negative plates immersed in an electrolyte, and a gas space within said container in which oxygen gas collects;
(b) sealing closed any vent openings through which gas can vent from said cell;
(c) installing a pressure relief valve in said cell, said pressure relief valve being in gas communication with said gas space and said atmosphere outside said cell so that excess gas can exit the cell and prevent over pressurization within said cell; and
(d) installing a secondary negative plate into said cell, said secondary negative plate being positioned to be in gas communication with said gas space and in contact with said electrolyte, said secondary negative plate being electrically connected to the negative plate by an electrical conductor.

28. The method of claim 27 wherein step (d) includes the installation of said secondary negative plate through a vent opening in said container.

29. The method of claim 27 wherein said pressure relief valve is provided as part of a vent assembly that also includes said secondary negative plate, and wherein steps (c) and (d) are carried out as a single step.

30. The method of claim 28 wherein said electrical conductor comprises an insulated wire extending from said vent assembly outside said cell to a negative post of said cell.

31. The method of claim 28 wherein said cell is a flooded lead acid cell, and said secondary plate comprises lead.

32. A valve regulated lead acid cell, comprising:
a sealed container;
a liquid electrolyte within said container, said electrolyte comprising sulfuric acid and having a liquid level;
a gas space in which oxygen collects;
at least one positive plate immersed in said electrolyte;
at least one negative plate immersed in said electrolyte, said negative plate comprising an active material that includes lead;
a secondary negative plate, said secondary negative plate being positioned to be in contact with the oxygen from said gas space and in ionic contact with said electrolyte, said secondary negative plate comprising an active material that includes lead;
an electrical conductor electrically connecting said secondary negative plate to said negative plate; and
a pressure relief valve disposed in said cell to allow excess gas to escape said container while preventing oxygen from outside said container from entering said cell.

33. A valve regulated lead acid cell in accordance with claim 32 wherein said negative plate and said secondary negative plate comprise pure lead.

34. A valve regulated lead acid cell in accordance with claim 32 further comprising a wick member in contact with said secondary negative plate and said electrolyte for providing indirect contact of said secondary negative plate with said electrolyte.

35. A valve regulated lead acid cell in accordance with claim 32 further comprising a catalyst in gas communication with said gas space, said catalyst being capable of combining oxygen and hydrogen to form water.

36. A method of controlling the voltage of a standby cell while on float, comprising:
(a) providing a cell having a sealed container; a liquid electrolyte within said container, a gas space in which oxygen collects; at least one positive plate immersed in said electrolyte; at least one negative plate immersed in said electrolyte, a secondary negative plate in gas communication with said gas space and in contact with said electrolyte; an electrical conductor electrically connecting said secondary negative plate to said negative plate; and a pressure relief valve disposed in said cell to allow excess gas to escape said cell while preventing oxygen from outside said cell from entering said cell; and
(b) controlling the amount of current between said negative plate and said secondary negative plate.

37. The method of claim 36 wherein said negative plate and said secondary negative plate comprise an active material that includes lead, and step (b) is carried out with a resistor.

38. The method of claim 37 wherein said resistor is a variable resistor.

39. The method of claim 37 further comprising the step of monitoring the voltage of said cell at least intermittingly, and adjusting an amount of resistance based on the voltage monitored.

40. A valve regulated cell in accordance with claim 1 further comprising a catalyst in gas communication with said gas space for converting oxygen and hydrogen to water.

41. A vent assembly in accordance with claim 16 further comprising a catalyst in gas communication with said gas space when said vent plug is installed in said vent opening, said catalyst being capable of converting oxygen and hydrogen to water.
